(19) United States
(12) Patent Application Publication
(10) Pub. No.: US 2005/0045238 A1
(43) Pub. Date: Mar. 3, 2005

(54) Micro valve device

(76) Inventors: Jing-Tang Yang, Hsinchu (TW); Jia-Hui Chen, Hsinchu (TW); Ker-Jer Huang, Hsinchu (TW); Alex C. Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/926,976

(22) Filed: Aug. 27, 2004

(30) Foreign Application Priority Data
Aug. 29, 2003 (TW) 092124057

(51) Int. Cl. F15C 1/06

(52) U.S. Cl. 137/833

(57) ABSTRACT

The present invention discloses a novel micro valve device, comprising a micro fluidic channel, which is formed by combining two hydrophobic plates, and the micro/nano structure on the wall surfaces of the channel are used to manipulate the mobility of the fluid in the channel. The function of the micro/nano structure mentioned above is to alter the micro or nano surface pattern on the wall surfaces of the channel. According to the relation between the surface pattern and the surface tension, the textured areas on the wall surfaces can change the mobility of the fluid in the channel. This effect is used as a switch in new types of micro valve devices for biomedical tests. Methods of making the micro valve device are described and include generating a micro/nano structure on the surfaces of the channel. The temporal control of different valve resistances can be achieved with different lengths, shapes, depths and materials of the micro/nano structures.

### BACKGROUND OF THE INVENTION

1. Field of Invention

The present invention relates to a micro valve device and, in particular, to a micro valve device that uses a micro/nano structure to control the mobility of a micro fluid.

2. Related Art

Microcapillary flows have a wide application in modem technologies, such as the PLED, OLED, optic-switches and biochips. The fluidic flow inside a micro channel is mostly driven by the capillary force. The capillary flow is affected by the surface tension and the hysteresis due to surface roughness.

Besides the capillary force experienced by the fluid, how to improve the mobility and control the direction of the fluid inside the micro channel is also an important subject. Many references show that imposing a heat source or electric field on the fluid inside the micro channel will alter the properties of the triple phase contact surface, providing wetting and flow direction control

In a micro fluid sensor, the micro valve is a key component. Not only it is used to control the flow and direction of fluid, it can further indirectly control the position, the stagnant time, and the passing ordering of the fluid. Any specific micro fluid detection mode requires an appropriate valve design to complete the necessary process.

In conventional valve designs, the required dynamic mechanical devices use either active or passive valves. There are no ideal designs for the active valves up to now. Take the thermal expansion type as an example. Though providing a sufficient force, it does not have a sensitive reaction, heats the fluid, and cause large energy loss. The piezoelectric valve requires a large voltage to produce a tiny displacement. The electromagnetic valve has the advantages of providing a large force, being sensitive, and consuming low power. Nevertheless, it is very hard for the micro valves to achieve the same performance of non-micro valves.

The passive micro valves are often used as one-way valves. Utilizing the fluid momentum and pressure, a certain part of the micro mechanical device is moved to open the valve for the fluid to pass through. If the fluid comes from the opposite direction, the device blocks the valve and thus the fluid. Generally speaking, the active valves are harder to make and require a dynamical supply system. The passive valves used in a system often complicate the fabrication process in order to comply with the system structure.

A micro fluidic actuator containing no mobile parts in the prior art is disclosed in the U.S. Pat. No. 6,565,727 B1, as shown in FIG. 1. The micro actuator utilizes electrowetting to change the surface tension between fluid and solid. An external circuit is used to control and change the potential difference between two electrodes 16a, 16b, thereby increasing the contact angle to effectively block the micro fluid flow. However, this micro valve design can only block the flow of small droplets. Moreover, the fluid 13 whose flow is controlled inside the channel has to more polarized than the fluid 15 that is not under control.

Another micro valve actuator disclosed in the U.S. Pat. No. 6,527,003 B1 is shown in FIG. 2. It is comprised of an upper substrate 20 and a low substrate 21, a vacuum chamber 23 enclosed by a thin film 24, and a thin thermal resistor disposed on the thin film 24. When a current is supplied to heat up the resistor, the thin film breaks to break the vacuum, generating a pressure difference with the ambient atmospheric pressure. Air enters via an air channel 27 to push the thin film back, blocking the fluid flow to generating the valve effect. Nonetheless, this valve effect can be used only once.

In summary, it is of great value if one can provide a micro valve with a simple manufacturing process, a shape easy to be defined, a high biocompatibility, and a design that can effectively block fluid.

### REFERENCES

1. A. D. Shenderov, “Actuators for Microfluidics without Moving Parts,” U.S. Pat. No. 6,565,727 B1, 2003.
2. J. R. Webster, “Micro Valve Actuator,” U.S. Pat. No. 6,527,003 B1, 2003.
3. W. Chen, A. Y. Fadeev, M. C. Hsieh, D. Oner, J. Youngblood, and T. J. McCarthy, “Ultrahydrophobic and Ultrayophobic Surfaces: Some Comments and Examples,” Langmuir, vol. 15, pp. 3395-3399, 1999.
4. D. Oner and T. J. McCarthy, “Ultrahydrophobic Surfaces Effects of Topography Length Scales on Wettability,” Langmuir, vol. 16, pp. 7777-7782, 2000.

### SUMMARY OF THE INVENTION

We disclose a novel micro valve device, comprising a micro fluidic channel, which is formed by combining two hydrophobic plates, and the micro/nano structure on the surfaces of the channel are used to manipulate the mobility of the fluid in the channel.

Methods of making the micro valve device are described and include generating a micro/nano structure on the surfaces of the channel. The temporal control of different valve resistances can be achieved with different lengths, shapes, depths and materials of the micro structures.

### BRIEF DESCRIPTION OF THE DRAWINGS

The present invention will become more fully understood from the detailed description given hereinbelow illustration only, and thus are not limitative of the present invention, and wherein:

FIG. 1 is a side view of a micro fluid actuator with no mobile parts in the prior art;

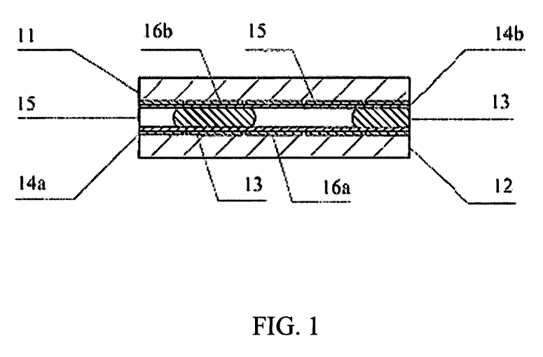

FIG. 2 is a side view of a micro valve actuator in the prior art;

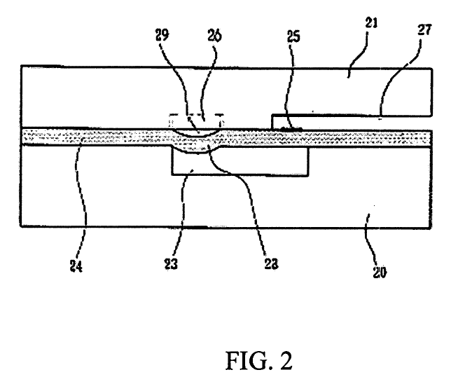

FIG. 3 is a schematic cross-sectional view of the disclosed micro valve;

FIG. 4 is a schematic view of the disclosed micro/nano structure region; and

FIG. 5(a) to 5(e) are flowcharts of the disclosed PDMS manufacturing process.

### DETAILED DESCRIPTION OF THE INVENTION

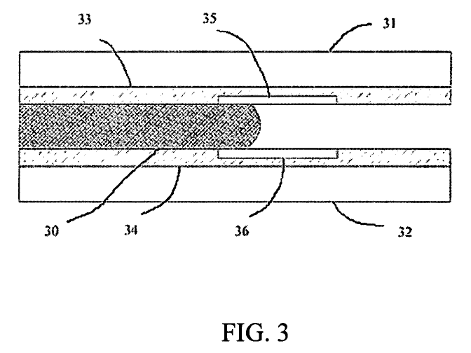

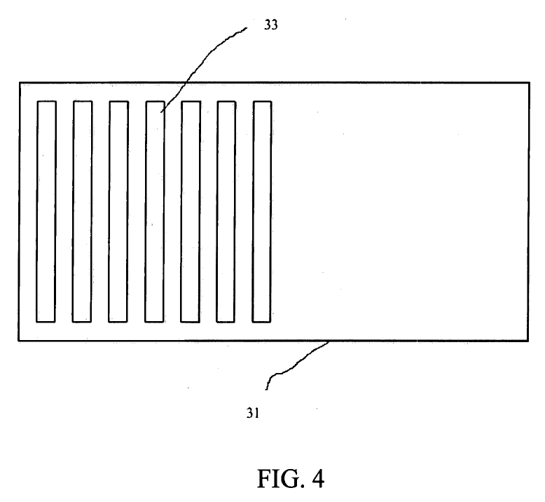

The disclosed micro valve, as shown in FIG. 3 and FIG. 4, includes micro fluidic channels 21, 32 made of plates with a concave structure. Hydrophobic layers 33, 34 are disposed thereon. The surfaces of the hydrophobic layers 33, 34 are etched with a micro/nano structure 35. 36. When the micro fluid 30 flows from left to right, it encounters the micro/nano structure 35, 36 in the red region and stop because of the valve effect. The special micro/nano structure 35, 36 is a surface with specific structure and shape. Different materials can be used to make micro valves with different resistances. They can be used in various micro-total-analysis systems or medical inspection systems with the advantages of easy assembly and no effect on the original system.

The disclosed micro valve design forms the micro/nano structure 35, 36 on the micro fluidic channel and utilizes a hydrophobic material as the channel wall. Changing the surface shape distribution can further increase the hydrophobicity of the hydrophobic material. When the micro fluid enters this region, the strong hydrophobicity blocks the fluid flow. We use this principle to make all kinds of valves with desired control properties. We describe the principle in more detail below.

When considering the thermal dynamic balance of micro fluid in a micro fluidic channel, the contact interfacial shape between different phases has to satisfy the Laplace-Young equation:

$$Δ P = γ ( \frac{1}{{r}_{1}} + \frac{1}{{r}_{2}} )$$

where γ is the surface tension, r1 and r2 are curvature radii of droplets, and ΔP is the pressure difference existing inside the droplet.

The contact angle research of a liquid droplet on a flat homogeneous solid surface is given in 1805 by the Young's equation found by Thomas Young:
γ_{SV}−γ_{SL}=γ_{LV}·cos θ
where γ represents the surface tension between two phases, the subscripts S means solid, L means liquid, V means vapor, and θ is the intrinsic contact angle.

The above equation is derived by assuming a balance; therefore, it is applicable to the surface of smooth and homogeneous solid. If the contact solid surface is a rough surface, the intrinsic contact angle θ in the Young's equation has to be multiplied by a correction coefficient in order to obtain the contact angle between a liquid droplet and a rough surface:
cos θ′=r·cos θ
One thus obtains the Wenzel equation, in which r is the roughness factor, defined to be the ratio between the actual contact surface area and the projected surface area:

$$r = \frac{{A}_{actual}}{{A}_{projected}}$$

From the Wenzel equation, one sees that the rough surface enhances the contact angle. If the intrinsic contact angle θ<90° (the contact surface is hydromaniac), then the contact angle on a rough surface θ′<θ. That is, the hydromaniacity of the rough surface is enhanced. If θ>90° (the contact surface is hydrophobic), then the contact angle θ′>θ.

That is, the hydrophobicity of the rough surface increases. Therefore, the roughness factor makes the hydromaniac surface more hydromaniac and the hydrophobic surface more hydrophobic.

The micro fluidic channel surface is formed with a special structure to block the procession of the micro fluid. Using this concept, one can readily prepare a channel with the valve effect.

For the further understanding of the invention, we provide in the following several preferred embodiments.

Embodiments:

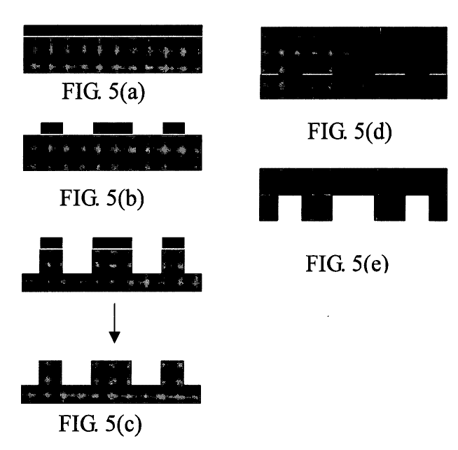

The preparation of the invention can be implemented in the following methods. One is to use polydimethyl siloxane (PDMS) to make the micro fluidic channel. The manufacturing process is shown in FIG. 5(a) to 5(e). First, a mother mold is fabricated, which is then used to make a micro fluidic channel using PDMS. Finally, two U-shape PDMS plates with the micro structure are combined to form the micro fluidic channel system with the valve effect. In particular, the mold is fabricated using the inductive coupling plasma (ICP) method to form a high aspect ratio structure. This method can result in an almost vertical wall. The detailed steps of this fabrication process are as follows. As shown in FIG. 5(a), first, a silicon wafer is coated with AZ4620 positive photo resist (PR). Subsequently, as shown in FIG. 5(b), it is then soft-baked, followed by exposure and development. A desired pattern is thus formed. Afterwards, the wafer is hard-baked to enhance the PR strength. Finally, as shown in FIG. 5(c), the PR on the wafer is removed using the ICP etching method, rendering the desired mold. In the next step, PDMS and a curing agent are mixed homogeneously according to a specific proportion, followed by vacuuming. Afterwards, as shown in FIG. 5(d), the PDMS is poured into the mold, followed by vacuuming again. The PDMS is hardened by hard-baking. Finally, as shown in FIG. 5(e), one obtains the micro channel after taking the PDMS off the mold. The micro fluidic channel system with the micro valve effect is obtained by bonding a flat PDMS and a PDMS with a micro fluidic channel. The bonding method can be achieved by using oxygen plasma to treat the PDMS surface, activating the surface. Once two property-changed surfaces are brought into contact, irreversible bonds will immediately form. However, the surface activation is temporary, the bonding has to be done within a few minutes.

The second method is to coat hexamethyldisilazane (HMDS) on a silicon substrate to enhance the adhesive power of PR, followed by spin-coating the PR. The PR can be AZ6112 or any other positive PR. After exposure and development, the pattern on the mask is transferred to the surface of the PR. Finally, the silicon substrate is treated by the ICP etching. A hydrophobic layer is then coated on the surface to enhance its hydrophobicity. The hydrophobic layer can be made of Parylene, Teflon, or other hydrophobic materials.

The third method is to spin-coat a layer of PR on a silicon substrate. The PR can be SU8 or any other negative PR. After exposure and development, the pattern on the mask is transferred to the surface of the PR. Finally, the silicon substrate is treated by the ICP etching. A hydrophobic layer can be then coated on the surface to enhance its hydrophobicity. The hydrophobic layer can be made of Parylene, Teflon, or other hydrophobic materials.

To better illustrate the feasibility of the invention, we use formulae derived from theory to estimate the micro valve pressure resistance. The capillary force of the surface tension on a unit area depends on the pressure resistance on the valve, the surface tension, the contact angle, the cross section of the capillary force, and the contact length. Using a surface area of 100 μm*100 μm for the valve, a surface tension of 0.0728 N/m between water and air, a contact length of 400 μm, and a contact angle of 165 degrees, we estimate the valve pressure resistance to be 2813 N/m2.

The implementation of the invention is as follows. The micro fluidic channel system with the valve effect is disposed on a spinning disk, using the centrifugal force as the driving force of the micro fluid. When the micro fluid enters the micro/nano structure region, it stops owing to the resistance of hydrophobic surface, rendering the valve effect. Using several valves on the micro fluidic channel system, one can readily fabricate a series of temporal controlled micro fluidic channel systems using micro vales with different resistances by designing the length, material, shape and depth of the micro/nano structures. They can be used as the control tools for medical tests and bio-analyses.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A micro valve device with a micro/nano surface structure, comprising: a micro fluidic channel formed with upper and lower plates with U-shape grooves, wherein a micro/nano structure region in the micro fluidic channel is made as a micro fluidic channel valve.

2. The micro valve device of claim 1, wherein the surface of the micro fluidic channel is made of a hydrophobic material.

3. The micro valve device of claim 1, wherein the cross section of the micro fluidic channel is selected from a rectangle and a circle.

4. The micro valve device of claim 1, wherein the micro/nano surface structure is formed on any surface of the micro fluidic channel and exists on a plurality of the surfaces.

5. The micro valve device of claim 1, wherein the width of the micro fluidic channel cross section is between several μm to several hundred μm.

6. The micro valve device of claim 1, wherein the height of the micro fluidic channel cross section is between several μm to several hundred μm.

7. The micro valve device of claim 1, wherein the surface of the micro/nano surface structure is made of a hydrophobic material.

8. The micro valve device of claim 1, wherein the micro/nano surface structure distribution region is composed of a plurality of sub-regions.

9. The micro valve device of claim 8, wherein the shape of the sub-region is selected from the group comprising a rectangle, a hexagon, and any polygon.

10. The micro valve device of claim 8, wherein the shape of the micro/nano surface structure is selected from the group comprising a rectangular cylinder, a circular cylinder, a groove cylinder, and any polygonal cylinder.

11. The micro valve device of claim 8, wherein the micro/nano surface structure distribution is selected from the group of an array distribution and an irregular distribution.

12. The micro valve device of claim 8, wherein the distribution density of the micro/nano surface structure, defined as the ratio between the micro structure region area and the micro structure total area, is between 0 and 1.

13. The micro valve device of claim 8, wherein the size of the micro/nano surface structure is nanometers to tens of micrometers, the range of which provides significant surface capillary forces.

14. The micro valve device of claim 8, wherein the height of the micro/nano surface structure is between several μm to several hundred μm.

15. A micro valve device with a micro/nano surface structure, comprising: a micro fluidic channel formed with upper and lower plates with U-shape grooves and a film coated on the surface of the micro fluidic channel, wherein a micro/nano structure region in the micro fluidic channel is made as a micro fluidic channel valve.

16. The micro valve device of claim 15, wherein the film on the micro/nano surface structure is hydrophobic and the film on the micro fluidic channel is selected from hydrophobic and hydromaniac.

17. The micro valve device of claim 15, wherein the cross section of the micro fluidic channel is selected from a rectangle and a circle.

18. The micro valve device of claim 15, wherein the micro/nano surface structure is formed on any surface of the micro fluidic channel and exists on a plurality of the surfaces.

19. The micro valve device of claim 15, wherein the width of the micro fluidic channel is between several μm to several hundred μm.

20. The micro valve device of claim 15, wherein the height of the micro fluidic channel is between several μm to several hundred μm.

21. The micro valve device of claim 15, wherein the micro/nano surface structure is hydrophobic.

22. The micro valve device of claim 15, wherein micro/nano surface structure distribution region consists of a plurality of sub-regions.

23. The micro valve device of claim 22, wherein the shape of the sub-region is selected from the group comprising a rectangle, a hexagon, and any polygon.

24. The micro valve device of claim 22, wherein the shape of the micro/nano surface structure is selected from the group comprising a rectangular cylinder, a circular cylinder, a groove cylinder, and any polygonal cylinder.

25. The micro valve device of claim 22, wherein the micro/nano surface structure distribution is selected from the group of an array distribution and an irregular distribution.

26. The micro valve device of claim 22, wherein the distribution density of the micro/nano surface structure, defined as the ratio between the micro structure region area and the micro structure total area, is between 0 and 1.

27. The micro valve device of claim 22, wherein the size of the micro/nano surface structure is nanometers to tens of micrometers, the range of which provides significant surface capillary forces.

28. The micro valve device of claim 22, wherein the height of the micro/nano surface structure is between several μm to several hundred μm.
